(19) United States
(12) Patent Application Publication
(10) Pub. No.: US 2016/0048458 A1
(43) Pub. Date: Feb. 18, 2016

(54) Computer Security Systems and Methods Using Hardware-Accelerated Access To Guest Memory From Below The Operating System

(71) Applicant: Bitdefender IPR Management Ltd., Nicosia (CY)

(72) Inventors: Andrei V. LUTAS, Satu Mare (RO); Sandor LUKACS, Floresti (RO)

(21) Appl. No.: 14/459,620

(22) Filed: Aug. 14, 2014

(51) Int. Cl. G06F 12/14; G06F 9/455

(52) U.S. Cl. CPC G06F 12/145; G06F 9/45545; G06F 2212/1052

(57) ABSTRACT

Described systems and methods allow computer security software to access a memory of a host system with improved efficiency. A processor and a memory management unit (MMU) of the host system may be configured to perform memory access operations (read/write) in a target memory context, which may differ from the implicit memory context of the currently executing process. In some embodiments, the instruction set of the processor is extended to include new categories of instructions, which, when called from outside a guest virtual machine (VM) exposed by the host system, instruct the processor of the host system to perform memory access directly in a guest context, e.g., in a memory context of a process executing within the guest VM.

### BACKGROUND

The invention relates to systems and methods for performing memory management in computer systems, and in particular, to systems and methods for accessing guest memory in hardware virtualization environments.

Computing systems typically use a physical memory (e.g., a semiconductor chip) to hold data manipulated by the processor during computation. Such data includes, for instance, processor instructions, inputs, and outputs of computation. Physical memory is accessed using an addressing system, wherein each addressable memory location has a unique physical address.

Modern software usually operates with an abstraction of physical memory, known as virtual memory. A virtual memory space is typically allocated to each application executing on the respective computer system. Virtual memory is addressable via a set of virtual addresses, also known as logical addresses. Each such virtual address is mapped, for instance by an operating system of the computer system, to a physical address within the physical memory. A hardware component, typically known as a memory management unit (MMU), may perform the actual virtual-to-physical address translations, using specialized devices and mechanisms such as translation lookaside buffers (TLB) and/or page tables.

Hardware virtualization technology allows the creation of simulated computer environments commonly known as virtual machines (VM), which behave in many ways as physical computer systems. In many applications, such as server consolidation and infrastructure-as-a-service, several virtual machines may run simultaneously on the same computer system, sharing hardware resources among them, thus reducing investment and operating costs. Each virtual machine may run its own operating system and/or software applications, separately from other virtual machines.

Memory management in such virtualized environments is made more complex by a second level of address translations. Each virtual machine operates with a virtual representation of the physical memory of the computer system. Such virtualized physical memory is addressable via addresses commonly known as guest physical addresses (GPA). Virtual memory used by each software application executing within the respective virtual machine is addressable using what is known as guest virtual addresses (GVA). When an application tries to access content located at a GVA, the memory management unit needs to perform a GVA-to-GPA translation, followed by a translation from the respective GPA to an address within the physical memory, usually known in the art of virtualization as a host physical address (HPA).

Since every memory access by guest software uses at least two levels of indirection, hardware virtualization may carry a substantial computational penalty. Such a penalty may be of particular concern for software that performs memory access operations frequently, such as computer security software (e.g., anti-malware, firewall, spyware detection, and behavioral filtering programs, among others), that monitors the way various applications access memory to determine whether the respective host system is under attack.

There is considerable interest in developing systems and methods of memory management which can increase the efficiency of memory access in a virtualization environment.

### SUMMARY

According to one aspect, a host system comprises at least one hardware processor configured to execute a virtual machine and a computer security program executing outside the virtual machine. The virtual machine comprises a virtualized processor and is configured to employ the virtualized processor to execute a guest process. The computer security program comprises a processor instruction instructing the processor to access a memory location indicated by a virtual address. The at least one hardware processor is further configured to, in response to receiving the processor instruction, determine according to the processor instruction whether to interpret the virtual address in a memory context of the virtual machine, and when the processor instruction indicates to interpret the virtual address in the memory context of the virtual machine, determine the memory location in the memory context of the virtual machine.

According to another aspect, a host system is configured to form a virtual machine and a computer security program executing outside the virtual machine. The virtual machine employs a virtualized processor to execute a guest process. The computer security program comprises a processor instruction instructing a hardware processor of the host system to access a memory location indicated by a virtual address. The host system further comprises a memory management unit (MMU) configured to receive a context identifier from the hardware processor, the context identifier indicating whether to interpret the virtual address in a memory context of the virtual machine, the context identifier determined by the hardware processor according to the processor instruction, and in response, when the context identifier indicates to interpret the virtual address in the memory context of the virtual machine, determine the memory location in the memory context of the virtual machine.

According to another aspect, at least one hardware processor of a host system is configured to receive for execution a processor instruction from a computer security program executing on the host system, the computer security program executing outside a virtual machine exposed on the host system, the virtual machine employing a virtualized processor to execute a guest process, and wherein the processor instruction instructs the at least one processor to access a memory location indicated by a virtual address. The at least one processor is further configure to, in response to receiving the processor instruction, determine according to the processor instruction whether to interpret the virtual address in a memory context of the virtual machine, and when the processor instruction indicates to interpret the virtual address in the memory context of the virtual machine, determine the memory location in the memory context of the virtual machine.

According to another aspect, a method protects a host system from computer security threats. The host system is configured to execute a virtual machine and a computer security program executing outside the virtual machine. The virtual machine employs a virtualized processor to execute a guest process. The computer security program comprises a processor instruction instructing at least one hardware processor of the host system to access a memory location indicated by a virtual address. The method comprises employing the at least one hardware processor, in response to receiving the processor instruction, to determine according to the processor instruction whether to interpret the virtual address in a memory context of the virtual machine. The method further comprises, when the processor instruction indicates to interpret the virtual address in the memory context of the virtual machine, employing the at least one hardware processor to determine the memory location in the memory context of the virtual machine.

According to another aspect, a non-transitory computer-readable medium stores a set of processor instructions, which, when executed by at least one hardware processor of a host system, cause the host system to execute a computer security program outside a virtual machine exposed on the host system. Executing the computer security program comprises executing an instruction instructing the at least one hardware processor to access a memory location indicated by a virtual address. Executing the instruction causes the at least one hardware processor to determine according to the instruction whether to interpret the virtual address in a memory context of the virtual machine. Executing the instruction further causes the at least one hardware processor, when the instruction indicates to interpret the virtual address in the memory context of the virtual machine, to determine the memory location in the memory context of the virtual machine.

### BRIEF DESCRIPTION OF THE DRAWINGS

The foregoing aspects and advantages of the present invention will become better understood upon reading the following detailed description and upon reference to the drawings where:

FIG. 1 shows an exemplary hardware configuration of a host computer system according to some embodiments of the present invention.

FIG. 2 shows an exemplary set of virtual machines exposed by a hypervisor executing on the host system, and a computer security module protecting the set of virtual machines from malware according to some embodiments of the present invention.

FIG. 3 shows an exemplary configuration of virtualized hardware exposed as a guest virtual machine according to some embodiments of the present invention.

FIG. 4 shows a set of exemplary memory address translations in a hardware virtualization configuration as shown in FIG. 2, according to some embodiments of the present invention.

FIG. 5 shows exemplary components of a processor and of a memory management unit (MMU) according to some embodiments of the present invention.

FIG. 6 shows an exemplary target context register of the processor, according to some embodiments of the present invention.

FIG. 7 shows an exemplary typical exchange of information between the processor and the MMU, as known in the art.

FIG. 8 shows an exemplary exchange of information between the processor and the MMU according to some embodiments of the present invention.

FIG. 9 shows an exemplary sequence of steps performed by the MMU during a memory access operation in a conventional computer system.

FIG. 10 illustrates an exemplary sequence of steps performed by the processor and/or by the MMU during a memory access operation, according to some embodiments of the present invention.

FIG. 11 shows an exemplary hardware configuration according to some embodiments of the present invention, the configuration enabling the MMU to carry out the sequence of steps illustrated in FIG. 10.

### DETAILED DESCRIPTION OF PREFERRED EMBODIMENTS

In the following description, it is understood that all recited connections between structures can be direct operative connections or indirect operative connections through intermediary structures. A set of elements includes one or more elements. Any recitation of an element is understood to refer to at least one element. A plurality of elements includes at least two elements. Unless otherwise required, any described method steps need not be necessarily performed in a particular illustrated order. A first element (e.g. data) derived from a second element encompasses a first element equal to the second element, as well as a first element generated by processing the second element and optionally other data. Making a determination or decision according to a parameter encompasses making the determination or decision according to the parameter and optionally according to other data. Unless otherwise specified, an indicator of some quantity/data may be the quantity/data itself, or an indicator different from the quantity/data itself. A computer program is a sequence of processor instructions carrying out a task. Computer programs described in some embodiments of the present invention may be stand-alone software entities or sub-entities (e.g., subroutines, libraries) of other computer programs. Unless otherwise specified, a computer security program is a computer program that protects equipment and data from unintended or unauthorized access, modification or destruction. Unless otherwise specified, a process is an instance of a computer program, such as an application or a part of an operating system, and is characterized by having at least an execution thread and a virtual memory space assigned to it, wherein a content of the respective virtual memory space includes executable code. Unless otherwise specified, a page represents the smallest unit of virtual memory that can be individually mapped to a physical memory of a host system. The term “logic” encompasses hardware circuitry having a fixed or a reconfigurable functionality (e.g., field-programmable gate array circuits), but does not encompass software emulating such functionality on a general-purpose computer. Unless otherwise specified, a register represents a storage component integrated with or forming part of a processor, and distinct from random-access memory (RAM). Computer readable media encompass non-transitory media such as magnetic, optic, and semiconductor storage media (e.g. hard drives, optical disks, flash memory, DRAM), as well as communication links such as conductive cables and fiber optic links. According to some embodiments, the present invention provides, inter alia, computer systems comprising hardware (e.g. one or more processors) programmed to perform the methods described herein, as well as computer-readable media encoding instructions to perform the methods described herein.

The following description illustrates embodiments of the invention by way of example and not necessarily by way of limitation.

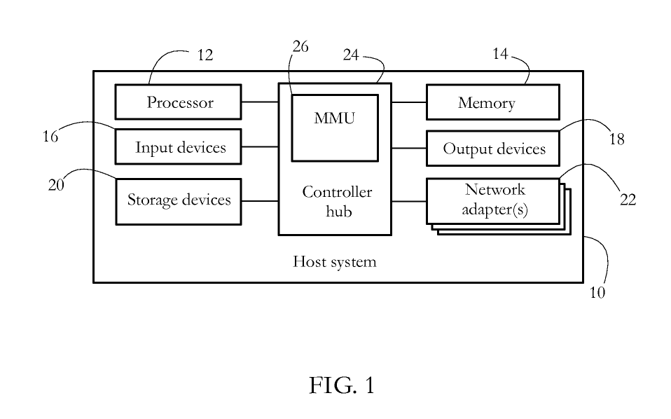

FIG. 1 shows an exemplary hardware configuration of a host system 10 according to some embodiments of the present invention. Host system 10 may represent a corporate computing device such as an enterprise server, or an end-user device such as a personal computer, tablet computer, or smartphone. Other exemplary host systems include TVs, game consoles, wearable computing devices, or any other device having a memory and a processor. Host system 10 may be used to execute a set of software applications, such as a browser, a word processing application, and an electronic communication (e.g., email, instant messaging) application, among others. In some embodiments, host system 10 is configured to support hardware virtualization and to expose a set of virtual machines, as shown below.

FIG. 1 illustrates a computer system; the hardware configuration of other host systems, such as smartphones and tablet computers, may differ. System 10 comprises a set of physical devices, including a processor 12, a memory unit 14, a set of input devices 16, a set of output devices 18, a set of storage devices 20, and a set of network adapters 22, all connected by a controller hub 24. In some embodiments, processor 12 comprises a physical device (e.g. multi-core integrated circuit formed on a semiconductor substrate) configured to execute computational and/or logical operations with a set of signals and/or data. In some embodiments, such logical operations are delivered to processor 12 in the form of a sequence of processor instructions (e.g. machine code or other type of software). Memory unit 14 may comprise volatile computer-readable media (e.g. RAM) storing data/signals accessed or generated by processor 12 in the course of carrying out instructions.

Input devices 16 may include computer keyboards, mice, and microphones, among others, including the respective hardware interfaces and/or adapters allowing a user to introduce data and/or instructions into host system 10. Output devices 18 may include display devices such as monitors and speakers, among others, as well as hardware interfaces/adapters such as graphic cards, allowing host system 10 to communicate data to a user. In some embodiments, input devices 16 and output devices 18 may share a common piece of hardware, as in the case of touch-screen devices. Storage devices 20 include computer-readable media enabling the non-volatile storage, reading, and writing of processor instructions and/or data. Exemplary storage devices 20 include magnetic and optical disks and flash memory devices, as well as removable media such as CD and/or DVD disks and drives. The set of network adapters 22 enables host system 10 to connect to a computer network and/or to other devices/computer systems. Controller hub 24 generically represents the plurality of system, peripheral, and/or chipset buses, and/or all other circuitry enabling the communication between processor 12 and devices 14, 16, 18, 20 and 22. For instance, controller hub 24 may include a memory management unit (MMU) 26, an input/output (I/O) controller, and an interrupt controller, among others. In another example, controller hub 24 may comprise a northbridge connecting processor 12 to memory 14 and/or a southbridge connecting processor 12 to devices 16, 18, 20, and 22. In some embodiments, MMU 26 may be integrated, in part or entirely, with processor 12, i.e., MMU 26 may share a common semiconductor substrate with processor 12.

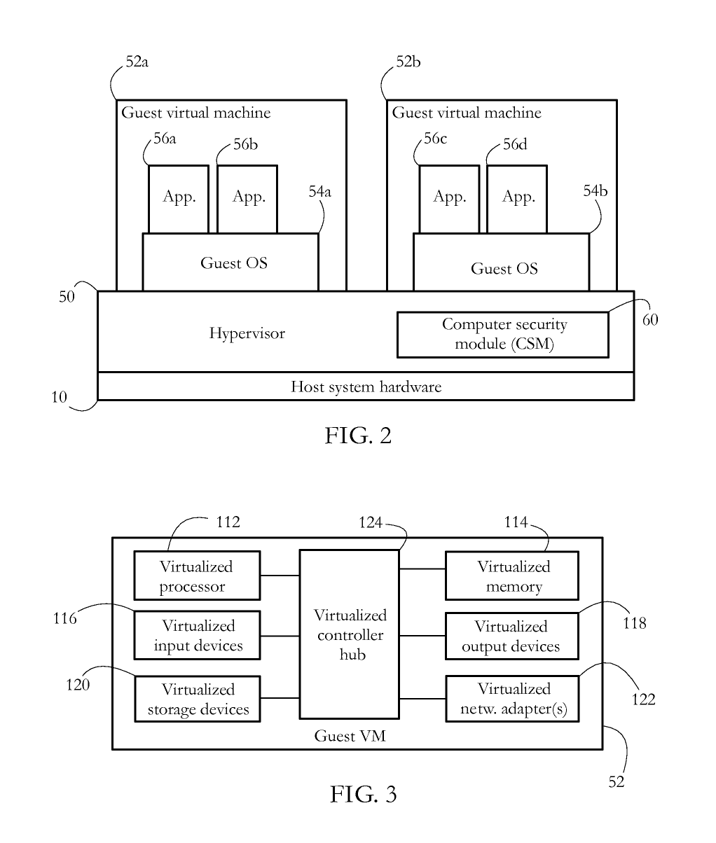

FIG. 2 shows an exemplary configuration, wherein host system 10 uses hardware virtualization technology to operate a set of guest virtual machines 52a-b exposed by a hypervisor 50. Such configurations are common in applications such as cloud computing and server consolidation, among others. A virtual machine (VM) is known in the art as an abstraction, e.g., a software emulation, of an actual physical machine/computer system, the VM capable of running an operating system and other applications. In some embodiments, hypervisor 50 includes software configured to create or enable a plurality of virtualized devices, such as a virtual processor and a virtual MMU, and to present such virtualized devices to software in place of the real, physical devices of host system 10. Such operations of hypervisor 50 are commonly known in the art as exposing a virtual machine. In some embodiments, hypervisor 50 allows a multiplexing (sharing) by multiple virtual machines of hardware resources of host system 10. Hypervisor 50 may further manage such multiplexing so that each guest VM 52a-b operates independently and is unaware of other VMs executing concurrently executing on host system 10. Examples of popular hypervisors include the VMware vSphere™ from VMware Inc. and the open-source Xen hypervisor, among others.

Each VM 52a-b may execute a guest operating system (OS) 54a-b, respectively. A set of exemplary applications 56a-d generically represent any software application, such as word processing, image processing, media player, database, calendar, personal contact management, browser, gaming, voice communication, data communication, and anti-malware applications, among others. Operating systems 54a-b may comprise any widely available operating system such as Microsoft Windows®, MacOS®, Linux®, iOS®, or Android™, among others. Each OS 54a-b provides an interface between applications executing within the respective VM and the virtualized hardware devices of the respective VM. In the following description, software executing on a virtual processor of a virtual machine is said to execute within the respective virtual machine. For instance, in the example of FIG. 2, applications 56a-b are said to execute within guest VM 52a, while applications 56c-d are said to execute within guest VM 52b. In contrast, hypervisor 50 is said to execute outside, or below, guest VMs 52a-b.

FIG. 3 shows an exemplary configuration of a virtual machine 52, as exposed by hypervisor 50. VM 52 may represent any of VMs 52a-b of FIG. 2. VM 52 includes a virtualized processor 112, a virtualized memory unit 114, virtualized input devices 116, virtualized output devices 118, virtualized storage 120, virtualized network adapters 122, and a virtualized controller hub 124. Virtualized processor 112 comprises an emulation of at least some of the functionality of processor 12, and is configured to receive for execution processor instructions forming part of software such as an operating system and other applications. Software using processor 112 for execution is deemed to execute within virtual machine 52. In some embodiments, virtualized memory unit 114 comprises addressable spaces for storing and retrieving data used by virtualized processor 112. Other virtualized devices (e.g., virtualized input, output, storage, etc.) emulate at least some of the functionality of the respective physical devices of host system 10. Virtualized processor 112 may be configured to interact with such devices as it would with the corresponding physical devices. For instance, software executing within VM 52 may send and/or receive network traffic via virtualized network adapter(s) 122. In some embodiments, hypervisor 50 may expose only a subset of virtualized devices to VM 52 (for instance, only virtualized processor 112, virtualized memory 114, and parts of hub 124). Hypervisor 50 may also give a selected VM exclusive use of some hardware devices of host system 10. In one such example, VM 52a (FIG. 2) may have exclusive use of input devices 16 and output devices 18, but lack a virtualized network adapter. Meanwhile, VM 52b may have exclusive use of network adapter(s) 22. Such configurations may be implemented, for instance, using VT-d® technology from Intel®.

Modern processors implement a hierarchy of processor privilege levels, also known in the art as protection rings. Each such ring or level is characterized by a set of actions and/or processor instructions that software executing within the respective ring is allowed to carry out. Exemplary privilege levels/rings include user mode (ring 3) and kernel mode (ring 0). Some host systems configured to support hardware virtualization may include an additional ring with the highest processor privileges (e.g., ring −1, root mode, or VMXroot on Intel® platforms). In some embodiments, hypervisor 50 takes control of processor 12 at the most privileged level (ring −1), thus creating a hardware virtualization platform exposed as a virtual machine to other software executing on host system 10. An operating system, such as guest OS 54a in FIG. 2, executes within the virtual environment of the respective VM, typically with lesser processor privilege than hypervisor 50 (e.g., in ring 0 or kernel mode). Common user applications, such as 56a-b, typically execute at lesser processor privilege than OS 34a (e.g., in ring 3 or user mode).

Some parts of applications 56a-b may execute at kernel privilege level, while some parts of OS 34a may execute in user mode (ring 3). When a software object attempts to execute an action or instruction requiring processor privileges higher than allowed by its assigned protection ring, the attempt typically generates a processor event, such as an exception or a fault, which transfers control of processor 12 to an entity (e.g., event handler of the operating system) executing in a ring with enough privileges to carry out the respective action.

In particular, some processor instructions may only be executed from the privilege level of hypervisor 50. In some embodiments, invoking such an instruction from within a virtual machine generates a virtual machine exit event (e.g., VMExit on Intel® platforms). VM exit events suspend the execution of the respective virtual machine and switch processor 12 to executing a handler routine outside the respective VM, at the highest privilege level, e.g., root mode or ring −1. Such handlers are typically part of hypervisor 50. In some embodiments, VM exits may also be triggered by other events, such as memory access violations. In one such example, when a software object executing within a VM attempts to write data to a memory page marked as non-writable, or to execute code from a memory page marked as non-executable, processor 12 may intercept the attempt, suspend the current execution, and switch to executing hypervisor 50. Such exit mechanisms may allow, for example, a computer security program to protect a virtual machine from outside the respective VM. The computer security program may intercept VM exit events occurring in response to certain actions performed by software running inside the VM, actions which may be indicative of a security threat. The computer security program may then block and/or further analyze such actions, potentially without the knowledge of in-VM software. Such methods may substantially strengthen computer security.

In some embodiments (e.g., FIG. 2), hypervisor 50 includes a computer security module (CSM) 60, configured to perform such computer security operations, among others. Module 60 may be incorporated into hypervisor 50 (for instance as a library), or may be delivered as a computer program distinct and independent from hypervisor 50, but executing at the privilege level of hypervisor 50. A single module 60 may be configured to protect multiple guest VMs executing on host system 10. Operations carried out by module 60 may include detecting an action performed by a process executing within a guest VM (e.g., calling certain functions of the OS, accessing a registry of the OS, downloading a file from a remote location, writing data to a file, etc.). Other operations of module 60 may comprise determining an addresses of a memory section containing a part of a software object executing within a guest VM, accessing the respective memory section, and analyzing a content stored within the respective memory section. Other examples of security operations include intercepting and/or restricting access to such memory sections, e.g., preventing the over-writing of code or data belonging to a protected process, and preventing the execution of code stored in certain memory pages.

To be able to protect a guest VM in a configuration as illustrated in FIG. 2 (i.e., from outside the respective VM), some embodiments of CSM 60 employ address translation data structures and/or address translation mechanisms of processor 12. Virtual machines typically operate with a virtualized physical memory (see, e.g., memory 114 in FIG. 3), also known in the art as guest-physical memory. Virtualized physical memory comprises an abstract representation of the actual physical memory 14, for instance as a contiguous space of addresses, commonly termed guest-physical addresses (GPA). Each such address space is uniquely attached to a guest VM, with parts of said address space mapped to sections of physical memory 14 and/or physical storage devices 20. In systems configured to support virtualization, such mapping is typically achieved using hardware-accelerated, dedicated data structures and mechanisms controlled by processor 12, known as second level address translation (SLAT). Popular SLAT implementations include extended page tables (EPT) on Intel® platforms, and rapid virtualization indexing (RVI)/nested page tables (NPT) on AMD® platforms. In such systems, virtualized physical memory may be partitioned in units known in the art as pages, a page representing the smallest unit of virtualized physical memory individually mapped to physical memory via mechanisms such as EPT/NPT, i.e., mapping between physical and virtualized physical memory is performed with page granularity. All pages typically have a predetermined size, e.g., 4 kilobytes, 2 megabytes, etc. The partitioning of virtualized physical memory into pages is usually configured by hypervisor 50. In some embodiments, hypervisor 50 also configures the SLAT structures, and therefore configures address translation between physical memory and virtualized physical memory. Such address translations are known in the art as guest-physical to host-physical (GPA-to-HPA) translations.

In some embodiments, the operating system executing within a VM sets up a virtual memory space for each process executing within the respective VM, said virtual memory space representing an abstraction of physical memory. Process virtual memory typically comprises a contiguous space of addresses, commonly known in the art as guest-virtual addresses (GVA). In some embodiments, virtual memory spaces are also partitioned into pages, such pages representing the smallest unit of virtual memory individually mapped by the OS to the virtualized physical memory of the respective VM, i.e., virtual to virtualized-physical memory mapping is performed with page granularity. The OS may configure a dedicated data structure, such as a page table, used by the virtualized processor of the respective VM to perform guest virtual to guest physical, or GVA-to-GPA address translations.

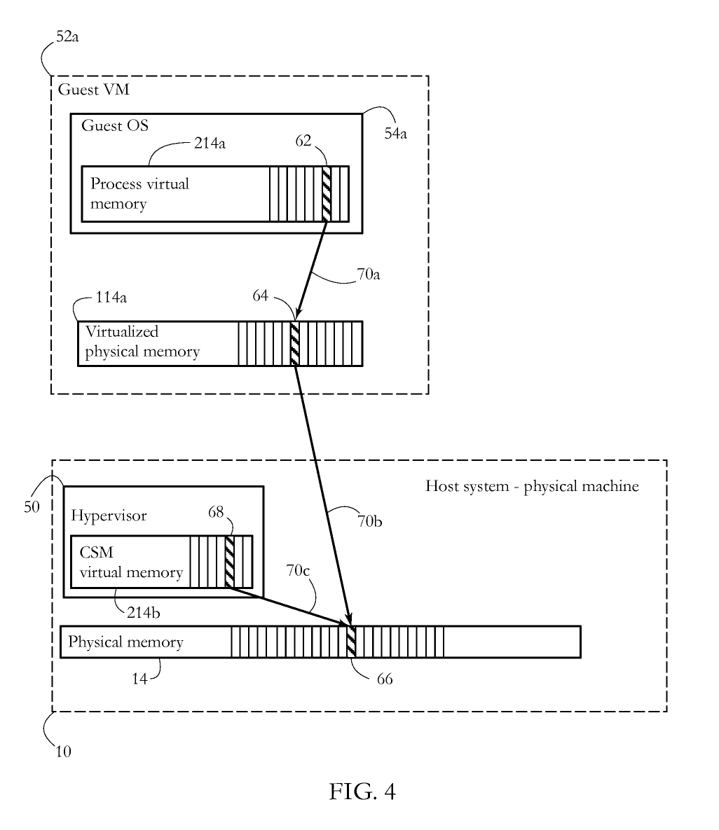

FIG. 4 illustrates an exemplary memory address translation in the embodiment of FIG. 2. Following exposure by hypervisor 50, guest VM 52a sees a virtualized physical memory space 114a as its own physical memory space. A process executing within guest VM 52a is assigned a virtual memory space 214a by guest OS Ma. When the process attempts to access memory at a guest-virtual address 62, GVA 62 is translated by the (virtualized) MMU of guest VM 52a into a guest-physical address 64 within virtualized physical memory space 114a. GVA-to-GPA translation 70a may proceed, for instance, according to page tables configured and controlled by guest OS 34a. GPA 64 is further mapped by MMU 26 to a host-physical address (HPA) 66 within physical memory 14 of host system 10. GPA-to-HPA translation 70b may proceed, for instance, according to SLAT structures configured by hypervisor 50.

Each virtual or virtualized physical memory space set up by the operating system or by the hypervisor may be seen as a context for memory address translations. Address translation from GVA 62 to GPA 64 is said to be performed in the context of the process which owns virtual memory space 214a, in the sense that such address translation uses page tables uniquely associated with the respective process. The same GVA may be translated to a totally different GPA in the memory context of another process. Similarly, address translation from GPA 64 to HPA 66 is said to be performed in the context of guest VM 52, in the sense that such address translations use a SLAT structure (e.g., page table) set up specifically for guest VM 52a. The same GPA may be translated to another HPA in the context of another VM.

The memory context of a guest VM, which may include the memory context of a process executing within the respective guest VM, will herein be referred to as a guest context. In some embodiments, a guest context of a guest VM comprises a page table configured for GVA-to-GPA translations for a process executing within the respective guest VM, and/or a SLAT structure (e.g., page table) configured for GPA-to-HPA translations for the respective guest VM.

Each process executing below guest VMs 52a-b is typically assigned a virtual memory space addressable via what is known in the art as host-virtual addresses (HVA). In the example of FIG. 4, hypervisor 50 sets up a virtual memory space 214b for computer security module 60. When module 60 is integrated within hypervisor 50, for instance as a library, memory space 214b may coincide with the virtual memory space of hypervisor 50. To manage such spaces, hypervisor 50 may configure dedicated data structures and mechanisms (e.g. page tables) used by MMU 26 to perform HVA-to-HPA translations such as translation 70c. In some embodiments, a memory context of a process executing at the level of hypervisor 50 comprises a page table configured for HVA-to-HPA translations for the respective process. Such a memory context will herein be referred to as a host context.

To perform computer security operations from below OS Ma, CSM 60 may need, among others, to determine a virtual address (e.g., GVA 62) used by a target process, and to access physical memory at the address corresponding to the respective GVA. Since both module 60 and the target process operate with virtual memory, each reference to GVA 62 from outside VM 52a typically requires processor 12 and/or MMU 26 to perform a chain of address translations comprising at least GVA-to-GPA translation 70a, GPA-to-HPA translation 70b, and HVA-to-HPA translation 70c. Moreover, since module 60 has no code and/or data of its own at address 66 (such code and/or data belonging to the target process), the page table entry allowing address translation 70c may not exist at the moment of introspection. Therefore, the respective page table entry may be created “on the fly” by CSM 60, an operation typically requiring allocating memory and introducing the respective entry at the appropriate position within the page table structure.

Due to the computational burden of multiple address translations carried out for every reference to a GVA of a guest process, conventional memory introspection may substantially impact the performance of a host system. In contrast, some embodiments of the present invention allow the elimination of at least translation 70c and associated page table manipulations. Such optimizations may be achieved, for instance, using a set of processor instructions, which, when executed from below a guest VM, instruct processor 12 to access a GVA directly in the guest context of the respective target process executing inside the guest VM, as detailed below.

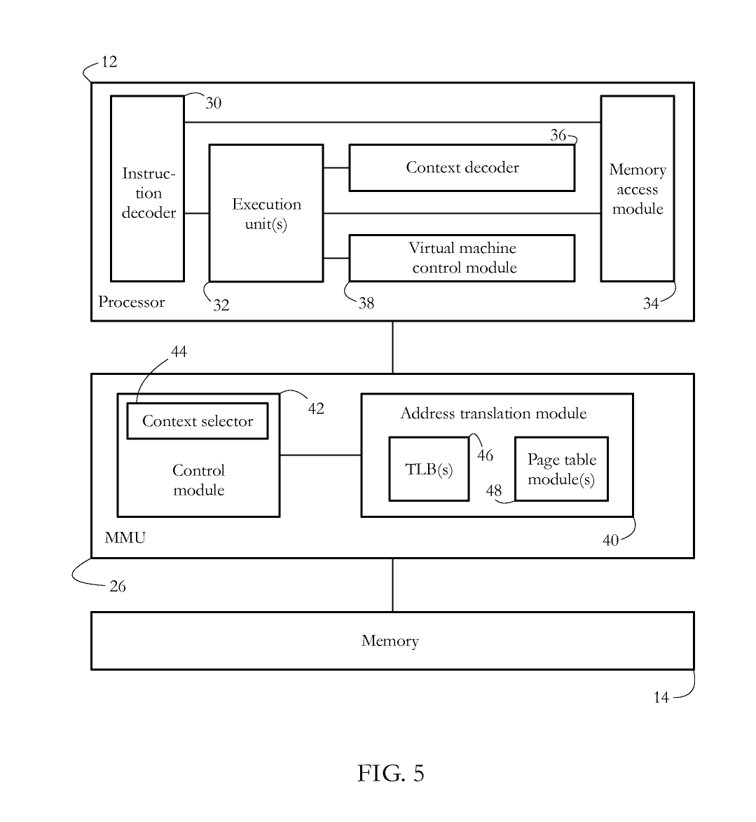

FIG. 5 shows exemplary hardware components of processor 12 and MMU 26 according to some embodiments of the present invention. The illustrated components are meant as generic devices performing the described functionality; structural details may vary substantially among implementations. For instance, each illustrated component may comprise multiple interconnected subsystems, not necessarily in physical proximity to each other. The illustrated components are not exhaustive; processor 12 and MMU 26 may include many other components (e.g., scheduler, interrupt controller, etc.), which were omitted from FIG. 5 for reasons of clarity. In some embodiments, MMU 26 may be integrated, in part or entirely, with processor 12 (e.g., on a shared die).

Modern processors are typically configured for multithreading. In such configurations, physical processor 12 may operate a plurality of cores, each core further comprising multiple logical processors, wherein each logical processor may process an execution thread independently of, and concurrently with, other logical processors. Multiple logical processors may share some hardware resources, for instance, a common MMU. For simplicity, FIG. 5 illustrates a single logical processor, and the associated description refers to the interaction between a single logical processor and a MMU. A skilled artisan will appreciate that the description may be extended to cover each logical processor of a multithreaded configuration.

Processor 12 may include logic/circuitry configured to carry out various stages of a processor pipeline. For instance, an instruction decoder 30 may perform instruction decoding operations, including translating each processor instruction into a set of opcodes or micro-opcodes. A set of execution units 32 connected to decoder 30 may perform the execution stage of the pipeline. Exemplary execution units 32 include, among others, an arithmetic logic unit (ALU) and a floating-point unit (FPU). A memory access module 34 connected to decoder 30 and execution unit(s) 32 includes logic configured to interact with memory 14, e.g., to fetch instructions from memory, to read data from memory, and to commit the result of execution of processor instructions to memory. Such interactions between module 34 and memory unit 14 are intermediated by MMU 26.

Processor 12 may further include a virtual machine control unit 38 configured to manage virtual machine state data. In some embodiments, a virtual machine state object (VMSO) comprises a data structure used internally by processor 12 to represent the current state of each virtualized processor exposed on host system 10. Exemplary VMSOs include the virtual machine control structure (VMCS) on Intel® platforms, and the virtual machine control block (VMCB) on AMD® platforms. VMSOs are typically set up by hypervisor 50. In some embodiments, processor 12 associates a region in memory with each VMSO, so that software may reference a specific VMSO using a memory address or pointer (e.g., VMCS pointer on Intel® platforms).

Each VMSO may comprise a guest state area and a host state area, the guest state area holding the CPU state and/or control registers of the respective guest VM, and the host state area storing the current state of hypervisor 50. In some embodiments, each VMSO further comprises an indicator of a guest context. For instance, the guest state area of the VMSO may include an identifier of a process currently under execution by the respective virtualized processor/VM. One example of such an identifier is stored within the CR3 register of the respective virtual processor, and indicates an address of a page table configured for GVA-to-GPA address translations corresponding to the respective process. The host state area of the VMSO may include a pointer (e.g., an EPT pointer on Intel® platforms) to a SLAT data structure configured for GPA-to-HPA address translations for the respective guest VM.

In some embodiments, processor 12 may store a part of a VMSO within dedicated internal registers/caches, while other parts of the respective VMSO may reside in memory. At any given time, at most one VMSO (herein termed the current VMSO) may be loaded onto the processor, identifying the virtual machine currently having control of processor 12. In a multithreading embodiment, a distinct VMSO may be loaded onto each distinct logical processor.

When processor 12 switches from executing the respective VM to executing hypervisor 50 (e.g., upon a VM exit), processor 12 may save the state of the respective VM to the guest state area of the current VMSO. When processor 12 switches from executing a first VM to executing a second VM, the VMSO associated to the first VM is unloaded, and the VMSO associated to the second VM is loaded onto the processor, the second VMSO becoming the current VMSO. In some embodiments, such loading/unloading of VMSO data to/from processor 12 is performed by virtual machine control module 38. Module 38 may further carry out the retrieval and/or saving of VMSO data from/to memory 14. In some embodiments, virtual machine control module 38 further manages an indicator (e.g., control bit, flag) indicating whether processor 12 currently executes code at the privilege level of hypervisor 50 (e.g., ring −1), as opposed to guest code within a VM (e.g., ring 0 or ring 3). Such an indicator may be used by MMU 26 in the process of address translation, as further described below.

In some embodiments, processor 12 further comprises a context decoder 36 connected to execution unit(s) 32 and/or to instruction decoder 30. Context decoder 36 includes logic/circuitry configured to identify a target context for address translation, according to a memory access instruction currently under execution by processor 12. In some embodiments, memory access includes reading content from, and writing content to physical memory 14. Exemplary memory access instructions of the x86 instruction set, denoted by their respective assembly mnemonics, include the MOV, ADD, XOR, CMOV, and XCHG instructions, among others.

Identifying the target context according to the current memory access instruction may include, among others, determining whether the current memory access instruction indicates to MMU 26 to perform memory address translations in a guest context or in a host context, and determining whether a virtual address should be interpreted as a GVA or as a GPA. Identifying the target context may further include identifying a target virtual machine in the context of which to perform memory access.

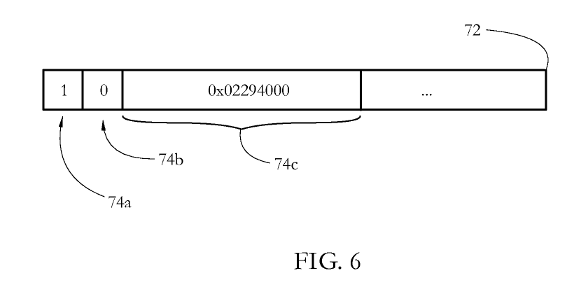

Context decoder 36 may further enable the communication of the target context to MMU 26. Such communication may be carried out through methods or devices known in the art. In one exemplary embodiment, context decoder 36 may write a set of indicators of the target context to a dedicated internal register of processor 12 (other embodiments may use a model-specific register or a section of memory). MMU 26 may then extract the context indicators from the respective register. FIG. 6 illustrates a target context register 72 of processor 12, written by context decoder 36 in response to identifying the target context. Register 70 may include a guest flag 74a which, when set to a predetermined value (e.g., 1), indicates that the current memory access instruction must be interpreted in a guest context. Register 72 may further include a field 74b indicating whether a virtual address should be interpreted as a GVA or GPA. In one example, a value of 1 may indicate a GPA, while a value of 0 may indicate a GVA. Yet another exemplary field 74c of context register 72 may indicate a target guest VM, for instance by storing an address (e.g., a HPA) of a VMSO of the respective guest VM.

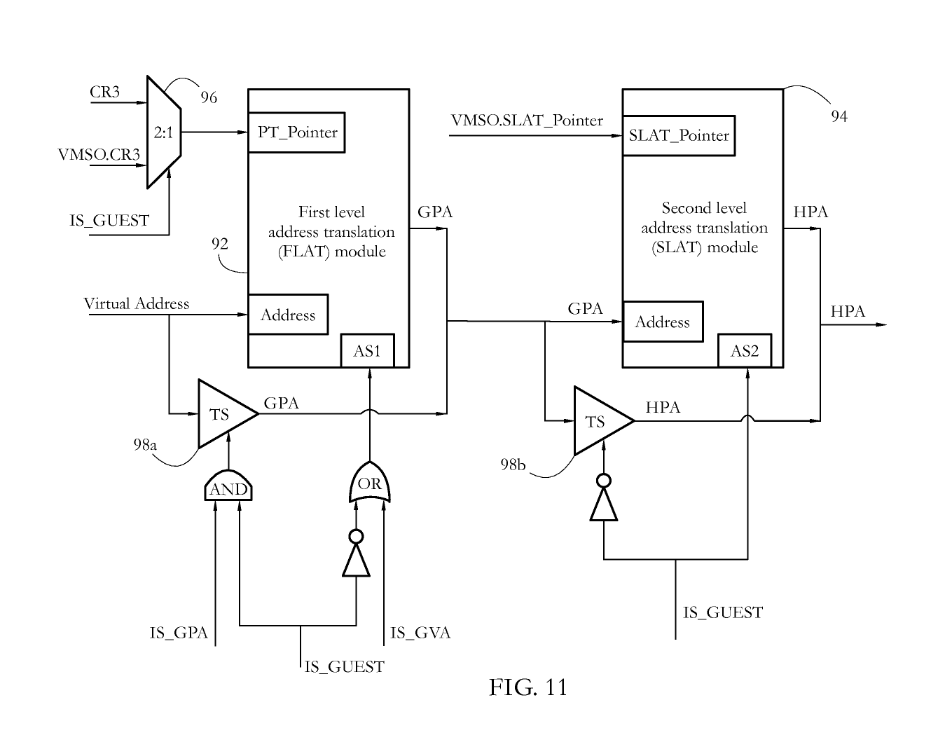

In another embodiment, context decoder 36 may communicate an indicator of the target context to MMU 26 as a set of control signals. One such example is described below in relation to FIG. 11.

Some embodiments of the present invention modify the instruction set architecture (ISA) of processor 12 to enable processor 12, when executing below a guest VM (e.g., in ring −1), to carry out memory access operations (read and/or write) directly in a guest context, i.e., in the memory context of a guest VM, or of a process executing within the respective guest VM. In some embodiments, the ISA is modified by the addition of a new set of memory access instructions, as illustrated below. Each memory access instruction may include a name field (e.g., mnemonic, opcode) representing an operator, and an operand field representing one or more operands. Context decoder 36 may identify a target context according to a content of the name field, according to a content of the operand field, or both. The mnemonics of the new instructions, as well as the order of operands, are meant as examples. A skilled artisan will appreciate that such details may be changed in many ways without affecting the scope of the present invention.

One category of memory access instructions according to some embodiments of the present invention may instruct processor 12 to read a content of memory in a guest context. Examples of such instructions are:

RGVA dest, addr [1] and

RGPA dest, addr [2]

wherein the mnemonic RGVA stands for read-guest-virtual-address, and the mnemonic RGPA stands for read-guest-physical-address. In the examples [1]-[2], the operand addr indicates a memory address: a virtual address in the case of RGVA (e.g., GVA 62 in FIG. 4), and a virtualized physical address in the case of RGPA (e.g., GPA 64 in FIG. 4). The operand addr may be specified in various ways, for instance as an explicit value, as a content of a processor register (e.g., eax), as a memory address combination (e.g., [4*rcx+128]), etc. Some embodiments introduce multiple read instructions, differentiated according to data type. For instance, there may be a RGVAB instruction to read data of type BYTE, a RGVAW instruction to read data of type WORD, etc.

Another category of memory access instructions may instruct processor 12 to write data to an address in a guest context. Examples of such instructions are:

WGVA addr, source [3] and

WGPA addr, source [4]

wherein the mnemonic WGVA stands for write-guest-virtual-address, and the mnemonic WGPA stands for write-guest-physical-address. In examples [3]-[4], the operand addr may indicate a virtual and a virtualized physical memory address, respectively. Write instructions may also be differentiated according to data type; for instance, there may be a WGVAD instruction to write data of type DWORD, etc.

In examples [1]-[2], the operand dest represents an indicator of a destination for the data being read, i.e., the semantics of such instructions are “read data from addr and place it in dest”. In examples [3]-[4], source represents an indicator of a source of the data being written, so the semantics of such instructions are “take data from source and write it to addr”. The source and/or destination of such memory access operations may be indicated in various ways, for instance, as an explicit memory address (e.g., a HVA or HPA), or as a processor register (e.g., eax). One such example could be:

WGVA [esi+0x100], eax

wherein processor 12 is instructed to write the content of the eax register to the guest-virtual address [esi+0x100], obtained by looking up the value stored in register esi and adding the hex value 0x100. In some embodiments, the source and/or destination for the read/write instructions may be hard-coded, e.g., a pre-determined processor register such as AL/AX/EAX/RAX.

In the examples [1]-[4], the guest context for address translation is understood to be the guest context of the currently executing guest VM (e.g., of processes executing within the current guest VM), identified, for instance, according to the VMSO currently loaded onto processor 12. In some embodiments, the guest context for address translation may not be restricted to the guest context of the currently executing VM, but may instead be explicitly specified as part of the syntax of the new memory access instructions. Such instructions may comprise three operands, for instance:

WGVA addr, source, guest [5]

Wherein operand guest includes an indicator of the guest VM in the memory context of which to perform address translation. In some embodiments, guest may be specified as a pointer (memory address, e.g., HPA) to a VMSO of the respective guest.

In some embodiments, the ISA of processor 12 is modified by adding a prefix to each of an existing set of memory access instructions. The presence of the prefix within the name field may indicate to processor 12 (e.g., to instruction decoder 30 or to context decoder 36) that the respective memory access instruction should be interpreted in a guest context, while the absence of the prefix may indicate to the processor to carry out the respective memory access in a default fashion (e.g., in the current execution context). A distinct prefix may further indicate, for instance, whether the operands of the prefixed instruction are GPAs or GVAs. Exemplary prefixed instructions are shown below:

GVA MOV eax, [esi+0x100] [6]

GPA MOV eax, [esi+0x100] [7]

In some embodiments, another category of instructions added to the ISA of processor 12 according to some embodiments of the present invention includes instructions configured to perform just address translation without memory access, i.e., without actually writing to or reading data from the respective addresses. Some examples of such instructions follow:

GVAGPA dest, source [8]

GPAHPA dest, source [9]

GVAHPA dest, source [10]

wherein example [8] instructs the processor to return in dest the GPA corresponding to a GVA taken from source, example [9] instructs the processor to return in dest the HPA corresponding to a GPA taken from source, and wherein example [10] instructs the processor to return in dest the HPA corresponding to a GVA taken from source. As in other examples above, source and dest may be actual memory addresses, processor registers, etc.

In some embodiments, MMU 26 (FIG. 5) intermediates memory access transactions between processor 12 and memory unit 14. Such transactions include, for instance, fetching processor instructions from memory, reading data from memory, and committing a result of a processor instruction to memory. MMU 26 typically receives a virtual address from processor 12, as well as an indicator of a type of memory access (read/write). In response, MMU 26 looks up a physical address (HPA) corresponding to the virtual address received from processor 12 and performs the requested memory access operation, i.e., either reads data from the respective HPA and transfers the data to processor 12, or writes the data received from processor 12 to the respective HPA. In the exemplary configuration of FIG. 5, communication with processor 12 and/or memory unit 14 (e.g., for data transfer) is managed by a control module 42 of MMU 26.

MMU 26 further comprises an address translation module 40 comprising logic/circuitry dedicated to translating a virtual address received from processor 12 into a corresponding physical address within memory unit 14. Translation module 40 may further comprise a set of translation lookaside buffers (TLB) 46 and a set of page table modules 48. In some embodiments, TLB 46 includes a local cache of address translations recently performed by MMU 26. In some embodiments, upon performing a successful address translation, MMU 26 stores an entry in the TLB, the entry comprising, among others, an indicator of a virtual address (e.g., GVA) and an indicator of the physical address (e.g., GPA and/or HPA) corresponding to the respective virtual address.

In some embodiments, address translation by module 40 is performed with page granularity, i.e., the address translation first determines the address of a memory page containing the GPA/HPA required for the memory access operation, and subsequently adds an offset to the page address to determine the actual physical address. The actual process of address translation may include determining an address of a virtual page hosting the virtual address to be translated, and determining an offset indicating a location of the virtual address within the respective virtual page. Next, module 40 may search within TLB(s) 46 for an entry corresponding to the respective virtual page. When an entry corresponding to the respective virtual page already exists within the TLB (a situation commonly known in the art as a TLB hit), an address of a physical page corresponding to the respective virtual page is retrieved from the TLB. The actual physical address corresponding to the virtual address to be translated is then obtained by adding the offset to the address of the physical page.

When no entry is found in TLB(s) 46 for the respective virtual page (TLB miss), address translation module 40 may employ page table module(s) 48 to perform a page table walk to determine the address of the physical page. A page table walk typically comprises a set of successive look-ups of addresses within a branched data structure comprising a set of page tables and/or directories, a concept well known in the art. In a hardware virtualization configuration as illustrated in FIG. 2, page table module(s) 48 may first employ a process-specific page table set up by the operating system to carry out a GVA-to-GPA translation (e.g., translation 70a in FIG. 4), and subsequently employ a SLAT structure set up by hypervisor 50 to perform a GPA-to-HPA translation (e.g., translation 70b in FIG. 4).

In some embodiments, each TLB entry is indexed with an indicator of the memory context in which the respective address translation was calculated. Such context indicators may include an identifier of a guest VM and an indicator of a process executing within the respective guest VM. Context-specific indexing may accelerate address translation, by allowing some contents of TLB(s) 46 to be preserved and reused after a change of context, most importantly when processor 12 alternates between executing one guest VM and executing another guest VM. Context-specific indexing of TLB entries may further allow address translation module 40 to perform address translations in arbitrary memory contexts, while still enjoying the benefits of hardware acceleration offered by TLB(s) 46.

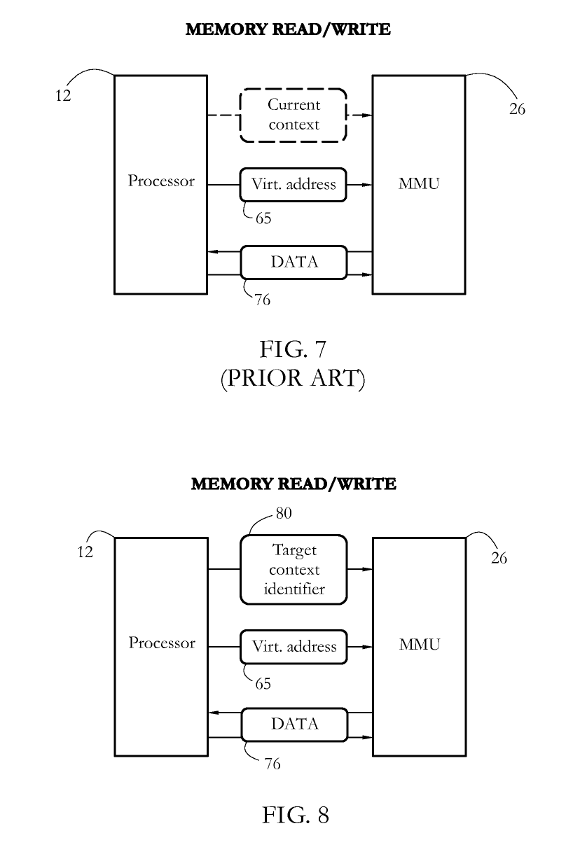

FIG. 7 shows an exemplary data exchange occurring between processor 12 and MMU 26 during execution of a memory access instruction in a conventional computing system. Processor 12 may transmit a virtual address 65 to MMU 26 and may either receive data 76 from, or transmit data 76 to MMU 26, depending on whether the respective memory access operation is a read or a write, respectively. In such conventional systems, the memory context for address translations is implicitly understood to be the context of the currently executing process. For instance, on Intel® platforms, the implicit context is indicated by a current content of the CR3 register (the CR3 register actually stores a pointer to a page table used by the process currently executing on processor 12). To perform correct address translations, MMU 26 may need to retrieve further implicit context information from processor 12. Such context information may include, among others, an indicator of whether processor 12 currently executes in protected or real mode (e.g., provided by a content of the CR0 register), and an indicator of whether processor 12 currently uses physical address extension (e.g., provided by a content of the CR4 register). In hardware virtualization configurations, the current, implicit context may further include a value of a flag/control bit indicating whether processor 12 currently executes in root mode (ring −1), as opposed to within a guest VM (ring 0 or 3), an indicator of the currently executing guest VM (e.g., the currently loaded VMSO), and an indicator of a SLAT structure configured for GPA-to-HPA translations (e.g., an EPT pointer).

In such conventional systems, when a process executing below a guest VM issues a memory access instruction, the current implicit context is that of the respective process (e.g., the CR3 register of processor 12 points to a page table of the respective process). Any address translations for such a process are therefore performed in a host context, i.e., virtual address 65 is interpreted as a HVA. Using the example of FIG. 4, in such a conventional system there is no direct way for software such as module 60 to read/write from/to GVA 62 (a virtual address of a guest process), or from/to GPA 64 (a virtualized physical address of the guest VM). Instead, the respective content is accessed via HVA 68.

In contrast, FIG. 8 shows an exemplary data exchange occurring between processor 12 and MMU 26 in some embodiments of the present invention. In addition to virtual address 65, processor 12 may transmit to MMU 26 a target context identifier 80. In some embodiments, context identifier 80 explicitly indicates a target context for address translations. The target context may coincide with the current implicit context (i.e., memory context of the process currently executing on processor 12, as indicated, for instance, by a content of the CR3 register on Intel platforms), or may be a guest context (e.g., a memory context of a process currently executing within a guest VM). In response to receiving context identifier 80 from processor 12, MMU 26 may proceed to perform a translation of virtual address 65 into a HPA, the translation performed in the memory context indicated by context identifier 80. For instance, when the target context is a guest context, virtual address 65 is interpreted as a GVA or GPA, and MMU 26 may use for translation TLB entries and/or page tables configured for a process executing within a guest VM.

In some embodiments, context identifier 80 comprises a content of a set of registers of processor 12, such as target context register 72. Such values may be written to their respective locations by context decoder 36, following instruction decoding operations. Transferring context identifier 80 from processor 12 to MMU 26 may be achieved using any method known in the art. In one example, MMU 26 may read the values of identifier 80 directly from register 72. In another example, context identifier 80 includes a set of control signal indicating, for instance, whether a virtual address should be translated in a guest context, and whether the respective virtual address is a GVA or a GPA.

In some embodiments, MMU 26 comprises a context selector 44, which may form part of control module 42, for instance. Context selector 44 may include logic configured to read context identifier 80 from a set of registers of processor 12 and/or from memory, or to receive a set of signals indicating a target context for address translation. Context selector 44 may further determine according to identifier 80 a set of parameters used in address translation, and to transmit such parameter values to address translation module 40. Such parameters may include, for instance, an address of a page table of a process (e.g., a content of the CR3 register), and an address of a SLAT structure. In one example, when target context identifier 80 indicates a host context, context selector 44 may present to address translation module 40 the current value of the CR3 register of processor 12. In contrast, when identifier 80 indicates a guest context, context selector 44 may present to address translation module 40 a value of the CR3 register of virtualized processor 112 of the currently loaded guest VM (e.g., taken from the currently loaded VMSO).

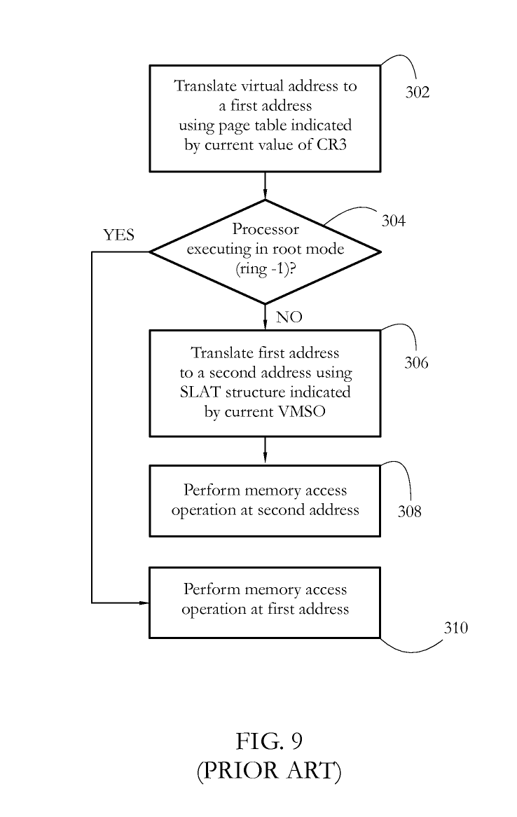

FIG. 9 shows an exemplary sequence of steps performed by a MMU during a memory access operation (e.g., part of executing a memory access instruction) in a conventional system, wherein memory context is implicitly assumed to be the context of the currently executing instruction. In hardware virtualization platforms, address translation is a two-phase process. First, virtual address 65 is translated to a first address (step 302), using a page table indicated by the current value of the CR3 register of the host machine. When the memory access is performed from the level of the hypervisor (root mode or ring −1), the first address actually represents a HPA, so the MMU may perform the requested memory access (read/write) at the first address, in a step 310. When the memory access is performed from within a guest VM, the first address represents a GPA, so the first address is further translated to a second memory address (step 306), which is the HPA required for the memory access operation. The GPA-to-HPA address translation (step 306) uses a SLAT structure indicated by the currently loaded VMSO. On Intel® platforms, step 306 may use an extended page table indicated by an EPT pointer of the current VMCS. A step 308 performs the requested memory access (read/write) at the second address.

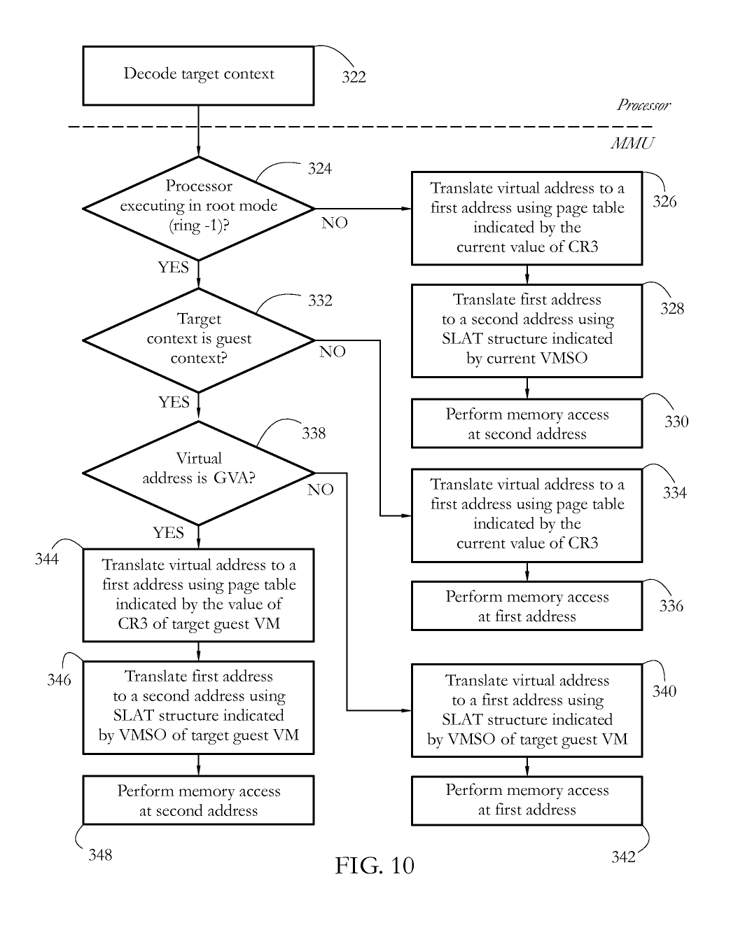

FIG. 10 illustrates an exemplary sequence of steps performed by processor 12 and/or by MMU 26 during a memory access operation, according to some embodiments of the present invention. In contrast to FIG. 9, memory access is not performed by default in the current, implicit memory context. Instead, in some embodiments, a specific memory context for address translations is communicated to MMU 26, for instance as target context identifier 80 (FIG. 8).

In a step 322, context decoder 36 may determine a target context for memory address translations, according to semantics and/or to operands of the current processor instruction. In some embodiments, when the current instruction is a conventional instruction such as MOV, ADD, XCHG, etc., decoder 36 may determine that the target context is the implicit context of the currently executing entity. When the current instruction is, for instance, of the kind illustrated by exemplary instructions [1]-[4], decoder 36 may determine that the target context is a guest context. Decoder 36 may further determine whether the target context is the context of the currently loaded VM (as in examples [1]-[4]), or the context of another VM (e.g., when the current instruction has three operands, as in example [5]). In some embodiments, decoder 36 may determine whether the target context is a guest context according to the presence or absence of an instruction prefix (e.g., as in exemplary instructions [6]-[7]). Decoder 36 may then enable the transfer of context identifier 80 to MMU 26, for instance by writing values indicative of the target context to register 72 or to memory.

In a step 324, MMU 26 determines whether processor 12 currently executes in root mode (e.g., VMXRoot on Intel® platforms), i.e., whether the current memory access instruction belongs to a process executing at the privilege level of hypervisor 50. Step 324 may include looking up a value of a control bit of processor 12. An outcome of no indicates that the respective instruction belongs to a process executing within a guest VM, so virtual address 65 is a GVA. In such cases, some embodiments may execute the current instruction in a conventional manner (see e.g., FIG. 9). In a sequence of steps 326-328, MMU 26 may translate virtual address 65 first into a GPA using a page table of the current process, pointed to by the current value of the CR3 register, and then translate the GPA into a HPA using a SLAT structure (e.g., EPT on Intel platforms) of the currently loaded VMSO. A step 330 then performs the actual memory access operation (read/write) at the respective HPA.

When processor 12 is currently executing in root mode, in a step 332, MMU 26 may determine, for instance according target context identifier 80, whether the target context of the current memory access instruction is a guest context, i.e., whether the instruction should be interpreted in the context of a guest process and/or guest VM, as opposed to the implicit host context. In some embodiments, step 332 comprises context selector 44 receiving input from context decoder 36 and/or reading the content of certain registers of processor 12 (e.g. register 72). When the target context is not a guest context, the virtual address referenced by the current memory access instruction is a HVA. In such cases, some embodiments may execute the current memory access instruction in a conventional manner: a step 334 may translate virtual address 65 into a HPA using a page table indicated by the current value of the CR3 register. A step 336 then performs the memory access operation (read/write) at the respective HPA.

When the target context is a guest context, in a step 338, MMU 26 may determine whether the virtual address referenced by the current memory access instruction is a GPA or a GVA. Some processor instructions introduced according to some embodiments of the present invention specify address 65 as a GPA (see examples [2], [4], [7], and [9]), while others specify address 65 as a GVA (see examples [1], [3], [5], [6], and [8]). Step 338 may include receiving input from context decoder 36 and/or reading a value from a processor register, such as target context register 72. When address 65 is a GPA, in a step 340 translates address 65 into a HPA using a SLAT structure of the target guest. When the target context is the context of the currently loaded guest, the SLAT may be indicated by the currently loaded VMSO (e.g., an EPT pointer of the currently loaded VMCS on Intel platforms). When the target context differs from the context of the currently loaded guest, in some embodiments, context selector 44 may look up an address of the VMSO of the target guest within register 72, and further determine an address of the corresponding SLAT structure according to the respective VMSO. A step 342 then performs the memory access operation (read/write) at the respective HPA.

When the virtual address referenced by the current memory access instruction is a GVA, a step 344 translates address 65 to a GPA according to a page table indicated by the CR3 register of the target guest VM. The respective CR3 value may be stored in the guest state area of the VMSO of the target guest. When the target context is that of the currently loaded guest, the respective CR3 value may be found in the currently loaded VMSO. A step 346 then translates the GPA to a HPA according to a SLAT structure indicated by the VMSO of the target guest, or by the currently loaded VMSO when the target context is that of the currently loaded guest. A step 348 then performs the memory access operation (read/write) at the respective HPA.

FIG. 11 shows an exemplary hardware configuration of MMU 26 according to some embodiments of the present invention, the illustrated configuration enabling processor 12 and MMU 26 to carry out the sequence of steps shown in FIG. 10. According to FIG. 11, MMU 26 may include a first level address translation (FLAT) module 92 comprising logic configured to receive an address and a pointer PT_Pointer, and to translate the respective address according to a page table indicated by PT_Pointer. In some embodiments, PT_Pointer is supplied with a value of a register of processor 12 (e.g., a CR3 register on x86 platforms). When the address supplied to FLAT module 92 is a GVA, the output of FLAT module 92 is a GPA; when the supplied address is a HVA, the corresponding output of FLAT module 92 is a HPA. In some embodiments, module 92 is selectively activated by an activation signal denoted as AS1. For instance, when the activation signal is on, module 92 performs the respective address translation; otherwise module 92 is bypassed.

MMU 26 may further comprise a second level address translation (SLAT) module 94 comprising logic configured to receive an address and a pointer SLAT_Pointer, and to translate the address according to a page table indicated by SLAT_Pointer. On Intel platforms, SLAT_Pointer may indicate, for instance, an EPT of the currently loaded VMCS. In some embodiments, SLAT module 94 is selectively activated by an activation signal denoted as AS2. For instance, when the activation signal is on, module 94 performs the requested address translation; otherwise module 94 is bypassed.

In some embodiments, MMU 26 uses a set of control signals to selectively turn modules 92-94 on and off, according to a type of instruction currently under execution. Such control signals may include, among others, IS_GUEST, IS_GVA, and IS_GPA illustrated in FIG. 11. IS_GUEST may indicate whether the current address translation should be performed in a guest context or not. For instance, IS_GUEST may be on when the current memory access instruction indicates a guest context (e.g., examples [1]-[10] above), and off otherwise. IS_GVA may be on when the referenced address is a GVA, and off otherwise. IS_GPA may be on when the referenced address is a GPA, and off otherwise. In some embodiments, IS_GUEST, IS_GVA, and IS_GPA form part of target context identifier 80, and are created by context decoder 36 (FIG. 5).

MMU 26 may further include two three-state gates (TS) 98a-b to selectively bypass translation modules 92-94, respectively. TS 98a is triggered by a control signal equivalent to (IS_GUEST AND IS_GPA), i.e., TS 98a shunts FLAT module 92 when the target context is a guest context and the referenced address is a GPA. TS 98b is triggered by a control signal equivalent to NOT IS_GUEST, i.e., TS 98b shunts SLAT module 94 when the target context is not a guest context.

FLAT module 92 may use as activation signal AS1 an equivalent of ((NOT IS_GUEST) OR IS_GVA), i.e., FLAT module 92 may be turned on when the target context is the host context, or whether the referenced address is a GVA. SLAT module 94 may use as activation signal IS_GUEST, i.e., module 94 may be turned on only when the target context is a guest context.

In some embodiments, MMU 26 further includes a 2:1 multiplexer 96 configured to selectively supply a PT_Pointer input to FLAT module 92. Multiplexer 96 may use IS_GUEST as a control signal. For instance, multiplexer 96 may output the current value of the CR3 register when the target context is not a guest context, and the value of the CR3 register of the currently loaded VMSO otherwise. In some embodiments, multiplexer 96 and TSs 98a-b form part of context selector 44 (FIG. 5).

The configuration illustrated in FIG. 11 performs address translations as following. When the target context is a host context (IS_GUEST is 0/off, e.g., address translation in the context of module 60), the referenced virtual address is a HVA, FLAT module 92 is on and translates the respective HVA into a HPA using the current value of the CR3 register. SLAT module 94 is turned off, since the output of FLAT module 92 is already the desired HPA. When the target context is a guest context (IS_GUEST is 1/on) and the referenced address is a GPA (IS_GPA is 1/on), FLAT module 92 is turned off, and the respective GPA is translated into a HPA by SLAT module 94 using a SLAT page table indicated by the currently loaded VMSO. When the target context is a guest context and the referenced address is a GVA (IS_GVA is 1/on), the GVA is first translated by FLAT module 92 using a page table indicated by the value of the CR3 of the currently loaded VMSO. The resulting GPA is further translated into a HPA by SLAT module 94 using a SLAT page table indicated by the currently loaded VMSO.

The exemplary systems and methods described above allow a MMU of a host system to perform memory access operations (read/write) in a target memory context, which may differ from the implicit memory context of the currently executing process. In some embodiments, the instruction set of the processor is extended to include new categories of instructions, which instruct the processor to perform memory access in a guest context, i.e., in a memory context of a process executing within a guest VM.

In some embodiments, a computer security program executes below all guest VMs exposed by the host system, and is configured to protect such guest VMs from malware. Such protection typically includes analyzing a content of a memory page used by a target process executing within a guest VM, and controlling access to the respective memory page. The target process typically references the respective memory page via a guest-virtual address (GVA). In conventional computer systems, to access a content of such a memory page, the computer security program may first need to compute a HPA corresponding to the respective GVA, and then reference the HPA via a virtual address (HVA) in the context of the computer security program.

To use the example in FIG. 4, in a conventional computer system there is no processor instruction allowing the computer security program, for instance, to “read from GVA 62”. Instead, such an operation currently requires translating GVA 62 to HPA 66, followed by an instruction to “read from HVA 68”. Therefore, each reference to GVA 62 by the computer security program in a conventional computer system requires at least three address translations (70a-c in FIG. 4). Moreover, since the computer security program has no code and/or data of its own at address 66 (such code and/or data belonging to the target process), a page table entry allowing address translation 70c may not even exist at the moment of referencing GVA 62. The respective page table entry is thus created “on the fly”, an operation usually requiring, among others, allocating memory and introducing the respective entry at the appropriate position within the page table structure.

In contrast, some embodiments of the present invention introduce processor instructions enabling, for instance, a direct “read from GVA 62” from outside the respective VM. In such embodiments, the address translation necessary for memory access is performed directly in the memory context of the target process. Such an approach may substantially accelerate memory access in hardware virtualization applications. For instance, in the example of FIG. 4, accessing memory directly in a guest context eliminates address translations of type 70c and potential page table manipulations associated with such translations. Computer security applications may benefit directly from such optimizations.

It will be clear to a skilled artisan that the above embodiments may be altered in many ways without departing from the scope of the invention. Accordingly, the scope of the invention should be determined by the following claims and their legal equivalents.

What is claimed is:

1. A host system comprising at least one hardware processor configured to execute:
a virtual machine comprising a virtualized processor and configured to employ the virtualized processor to execute a guest process; and
a computer security program executing outside the virtual machine, the computer security program comprising a processor instruction instructing the processor to access a memory location indicated by a virtual address, and
wherein the at least one hardware processor is further configured to, in response to receiving the processor instruction:
determine according to the processor instruction whether to interpret the virtual address in a memory context of the virtual machine; and
when the processor instruction indicates to interpret the virtual address in the memory context of the virtual machine, determine the memory location in the memory context of the virtual machine.

2. The host system of claim 1, wherein executing the processor instruction causes the at least one hardware processor to read a content of memory from the memory location.

3. The host system of claim 1, wherein executing the processor instruction causes the at least one hardware processor to write data to memory at the memory location.

4. The host system of claim 1, wherein determining the memory location in the memory context of the virtual machine comprises determining the memory location according to a page table of the guest process.

5. The host system of claim 1, wherein determining the memory location in the memory context of the virtual machine comprises determining the memory location according to a page table set up for the virtual machine by a hypervisor exposing the virtual machine.

6. The host system of claim 1, wherein the at least one hardware processor is further configured, when the processor instruction indicates not to interpret the virtual address in the memory context of the virtual machine, to determine the memory location according to a page table of the computer security program.

7. The host system of claim 1, wherein the processor instruction includes a opcode field, and wherein the at least one hardware processor is configured to determine whether to interpret the virtual address in the memory context of the virtual machine according to a content of the opcode field.

8. The host system of claim 7, wherein the at least one hardware processor is further configured to determine according to the opcode field whether the virtual address is a guest-virtual address (GVA) within a virtual memory space of the guest process.

9. The host system of claim 7, wherein the at least one hardware processor is further configured to determine according to the opcode field whether the virtual address is a guest-physical address (GPA) within a virtual memory space of the virtual machine.

10. The host system of claim 1, wherein the processor instruction includes an operand field, and wherein the at least one hardware processor is configured to determine whether to interpret the virtual address in the memory context of the virtual machine according to a content of the operand field.

11. The host system of claim 1, wherein the processor instruction includes a prefix field, and wherein the at least one hardware processor is configured to determine whether to interpret the virtual address in the memory context of the virtual machine according to a content of the prefix field.

12. A host system configured to form:
a virtual machine employing a virtualized processor to execute a guest process; and
a computer security program executing outside the virtual machine, the computer security program comprising a processor instruction instructing a hardware processor of the host system to access a memory location indicated by a virtual address, and wherein the host system comprises a memory management unit (MMU) configured to:
receive a context identifier from the hardware processor, the context identifier indicating whether to interpret the virtual address in a memory context of the virtual machine, the context identifier determined by the hardware processor according to the processor instruction; and
in response, when the context identifier indicates to interpret the virtual address in the memory context of the virtual machine, determine the memory location in the memory context of the virtual machine.

13. The host system of claim 12, wherein the at least one hardware processor is further configured, when the processor instruction indicates not to interpret the virtual address in the memory context of the virtual machine, to determine the memory location according to a page table of the computer security program.

14. The host system of claim 12, wherein receiving the context identifier comprises reading a content of a register of the hardware processor and determining according to the content whether to interpret the virtual address in the memory context of the virtual machine.

15. The host system of claim 12, wherein receiving the context identifier comprises receiving a control signal from the hardware processor and determining according to a value represented by the control signal whether to interpret the virtual address in the memory context of the virtual machine.

16. At least one hardware processor of a host system, the at least one hardware processor configured to:
receive for execution a processor instruction from a computer security program executing on the host system, the computer security program executing outside a virtual machine exposed on the host system, the virtual machine employing a virtualized processor to execute a guest process, and wherein the processor instruction instructs the at least one processor to access a memory location indicated by a virtual address;
in response to receiving the processor instruction, determine according to the processor instruction whether to interpret the virtual address in a memory context of the virtual machine; and
when the processor instruction indicates to interpret the virtual address in the memory context of the virtual machine, determine the memory location in the memory context of the virtual machine.

17. A method of protecting a host system from computer security threats, the host system configured to execute:
a virtual machine employing a virtualized processor to execute a guest process; and
a computer security program executing outside the virtual machine, computer security program comprising a processor instruction instructing at least one hardware processor of the host system to access a memory location indicated by a virtual address,
the method comprising:
employing the at least one hardware processor, in response to receiving the processor instruction, to determine according to the processor instruction whether to interpret the virtual address in a memory context of the virtual machine; and
when the processor instruction indicates to interpret the virtual address in the memory context of the virtual machine, employing the at least one hardware processor to determine the memory location in the memory context of the virtual machine.

18. The method of claim 17, further comprising, in response to determining whether to interpret the virtual address in the memory context of the virtual machine:
employing the at least one hardware processor to transmit a context indicator indicating whether to interpret the virtual address in the memory context of the virtual machine to a memory management unit (MMU) coupled to the at least one hardware processor; and
employing the MMU, in response to receiving the context indicator, when the context indicator indicates to interpret the virtual address in the memory context of the virtual machine, to determine the memory location in the memory context of the virtual machine.

19. A non-transitory computer-readable medium storing a set of processor instructions, which, when executed by at least one hardware processor of a host system, cause the host system to execute a computer security program outside a virtual machine exposed on the host system, wherein executing the computer security program comprises executing an instruction instructing the at least one hardware processor to access a memory location indicated by a virtual address, and wherein executing the instruction causes the at least one hardware processor to:
determine according to the instruction whether to interpret the virtual address in a memory context of the virtual machine; and
when the instruction indicates to interpret the virtual address in the memory context of the virtual machine, determine the memory location in the memory context of the virtual machine.
